(19) United States
(12) Patent Application Publication
(10) Pub. No.: US 2026/0326379 A1
(43) Pub. Date: Oct. 22, 2026

(54) ADDITIVE MANUFACTURING USING A BUILD PROCESS WITH LAZY LOCAL SLICING

(71) Applicant: Siemens Industry Software Inc., Plano, TX (US)

(72) Inventors: Gaurav Ameta, Princeton, NJ (US); David Madeley, Solihull (GB); Elena Arvanitis, Princeton, NJ (US); Wenjie Yao, Princeton, NJ (US)

(73) Assignee: Siemens Industry Software Inc., Plano, TX (US)

(21) Appl. No.: 19/114,812

(22) PCT Filed: Sep. 30, 2022
(86) PCT No.: PCT/US2022/077337

§ 371 Date: Mar. 25, 2025

(51) Int. Cl. B29C 64/386; B33Y 50/00; G05B 19/4099

(52) U.S. Cl. CPC B29C 64/386; G05B 19/4099; B33Y 50/00; G05B 2219/49014

(57) ABSTRACT

Computer-implemented system and method are provided for generating an additive manufacturing (AM) build program used to build an object having a manifold boundary body. A manufacturing definition module merges build information and AM machine schema information for a manufacturing definition. The build information includes specification of region-based build parameters and the machine schema information includes AM machine specific parameters related to material build by layers. Slice generation module performs a direct slicing algorithm of a 3D CAD model defining the geometry for the object, wherein slices of the model are defined according to layer thickness along a slicing direction. A region based recipe module is configured to generate annotated slices, wherein each slice is annotated with information based on the manufacturing definition. The annotated slices are sent to an edge computing device controlling the AM machine to be converted to a final build file with tool path and process parameters.

### TECHNICAL FIELD

This application relates to computer aided manufacturing (CAM). More particularly, this application relates to a CAM-based process that generates a slice build plan for additive manufacturing.

### BACKGROUND

Additive Manufacturing (AM) process enables complex geometry and heterogeneous materials to be designed together and manufactured. Currently, these large complex heterogeneous material-based geometries are faceted, sliced and converted to build files, which contain the parameters and instructions for the AM device to build the material layer by layer. The processing of complex geometries and transmission of build files has become a memory burden on design applications, manufacturing process planning applications and manufacturing hardware to finally produce these complex designs. The problem is the rigid architecture and requirements of files with explicit representation of geometry and manufacturing parameters in the current AM build processors.

In designing for AM, lattices with different types of unit cells and/or defined by implicit functions aid in reducing material while retaining critical strength/stiffness. As the number of unit cells or complexity of the overall geometry grows, resultant faceted models become intractable, as they would contain trillions or more facets. Such large number of facets lead to extremely large file sizes (>4 GB) that are difficult to send, store or process. In addition, the faceted models can be sliced and stored as intermediate faceted model files before creating toolpath commands in build files. The extremely large build files (~100 GB) are then sent to AM machines. Since the files are very large, they may be split into multiple builds/runs for the AM machines, causing alignment error and cumbersome work. Some research proposes direct slicing of CAD geometry without the need for intermediate faceted model files. However, these CAD geometries were not highly complex (e.g., billions of lattice unit cells), and the main purpose was to reduce the inaccuracy in creating a faceted model file.

### SUMMARY

To overcome the limitations of state of the art build file generation, method and system are disclosed which provide a flexible build processor for AM of highly complex geometries that utilizes a lazy, local slice and build approach without the need to create intermediate files of faceted bodies.

According to a first aspect, a computer-implemented system is provided for generating an additive manufacturing (AM) build program used to build an object conforming to a manifold boundary body, the system including a processor and a memory having modules stored thereon with instructions to be executed by the processor. A manufacturing definition module is configured to merge build information and AM machine schema information for a manufacturing definition. The build information includes specification of region-based build parameters and the machine schema information includes AM machine specific parameters related to material build (e.g., deposition) by layers. A slice generation module is configured to perform a direct slicing algorithm of a 3D CAD model defining the geometry for the object, wherein slices of the model are defined according to layer thickness along a slicing direction. A region based recipe module is configured to generate annotated slices, wherein each slice is annotated with information based on the manufacturing definition. The annotated slices are sent to an edge computing device controlling the AM machine to be converted to a final build file with tool path and process parameters.

According to a further aspect, a computer-implemented method is provided for generating an additive manufacturing (AM) build program used to build an object conforming to a manifold boundary body. Build information and AM machine schema information for a manufacturing definition are merged. The build information includes specification of region-based build parameters and the machine schema information includes AM machine specific parameters related to material build (e.g., deposition) by layers. A direct slicing algorithm of a 3D CAD model defining the geometry for the object is performed, wherein slices of the model are defined according to layer thickness along a slicing direction. Annotated slices are generated, where each slice is annotated with information based on the manufacturing definition. The annotated slices are sent to an edge computing device controlling the AM machine to be converted to a final build file with tool path and process parameters.

### BRIEF DESCRIPTION OF THE DRAWINGS

Non-limiting and non-exhaustive embodiments of the present disclosure are described with reference to the following FIGURES, wherein like reference numerals refer to like elements throughout the drawings unless otherwise specified.

FIG. 1A shows an example of a complex structure for additive manufacturing (AM) by layers in accordance with embodiments of this disclosure.

FIG. 1B shows an example of an interior layer of the structure used for contour analysis.

FIG. 1C shows an example of layer regions defined within the model used for a manufacturing recipe in accordance with embodiments of this disclosure.

FIG. 2 is a flow diagram illustrating an example of a process for AM build program generation in accordance with embodiments of this disclosure.

FIG. 3 illustrates an example of ray-casting in accordance with an embodiment of this disclosure.

FIG. 4 shows an example of a computing environment in which embodiments of the present disclosure may operate.

### DETAILED DESCRIPTION

Methods and systems are disclosed to solve the technical problem of inefficient additive manufacturing (AM) with respect to the conversion of 3D faceted body model files into build files that an AM machine can execute for building of material layers of a manifold object. A region-based manufacturing schema is processed to enable an object design having different regions of heterogeneous materials, physical characteristics, and/or build specifications to be modeled and built without overloading the AM machine processing resources.

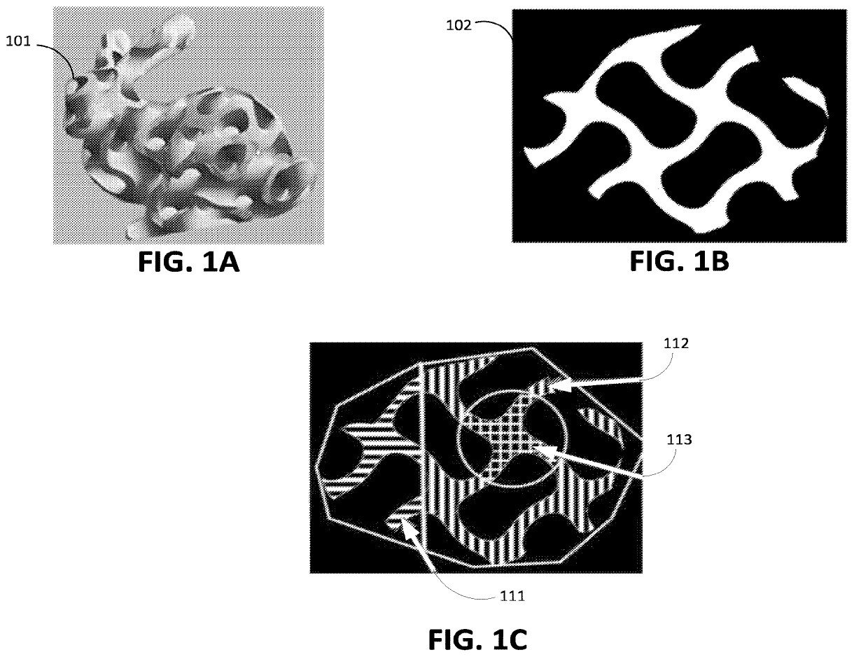

FIG. 1A shows an example of a complex structure for additive manufacturing (AM) by layers in accordance with embodiments of this disclosure. In this illustrative example, a target design for AM has a 3D geometry 101 according to the Stanford bunny model, a well known standard model in CAD industry as a challenging test for modeling techniques applied to curvy, non-prismatic shapes. The interior material has a gyroid characteristic (i.e., a type of triply periodic minimum surface), which has applications in industry (e.g., heat exchangers). Hence, embodiments of this disclosure are capable of modeling a gyroid structure that can be trimmed to boundaries having complex curves with a manifold boundary.

FIG. 1B shows an example of an interior layer 102 of the structure 101 used for contour analysis. The structure 101 is divided into multiple layers, where the layers are arranged as stackable slices of the structure 101, each layer defined given a particular build direction and layer thickness. In this example, white regions show where material should be built while black regions show empty space. Layer 102 includes one external contour and two internal contours. External contours have material inside them while internal contours have material outside them.

FIG. 1C shows an example of layer regions defined within the model used for a manufacturing recipe in accordance with embodiments of this disclosure. In an embodiment, different regions may be defined within each layer to designate region-based manufacturing recipes for specification of hatch pattern or process parameters. Examples of regions include upskin, downskin, inside regions, among others. An upskin region is defined as the sections in the layer where there is no material in the layer above but has material in the layer below. A downskin region is defined as the sections in the layer where there is material in the layer above, but no material in the layer below. There may be support structures below the downskin region (e.g., temporary support material built to support the layers only during the build process, which can be removed after the AM build is completed), but such support structures, if required, can have different build parameter specifications. An inside region is defined as sections in the layer where there is material in both the layer above and below. As a practical AM example in which laser powder bed fusion is applied, different scan speeds or laser power may be specified for the upskin, downskin, and inside regions. Furthermore, additional regions can be defined to segment the type of hatch pattern or build parameters, such as shown by regions 111, 112, 113 in FIG. 1C.

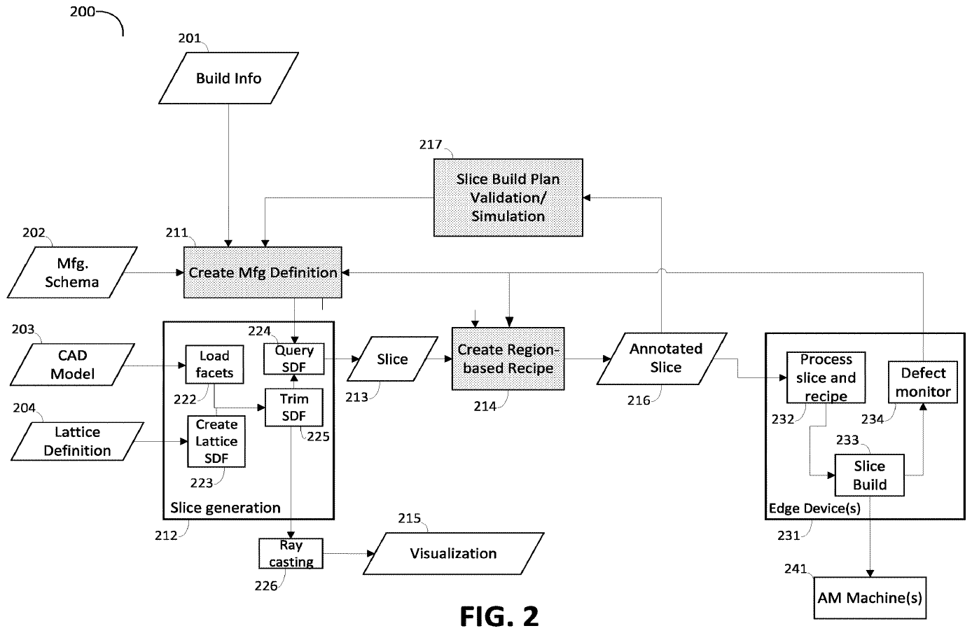

FIG. 2 is a flow diagram illustrating an example of a process for AM build program generation in accordance with embodiments of this disclosure. Process 200 controls data flow for a proposed manufacturing schema involving build slices and region based manufacturing recipes sent to one or more edge devices 231 that operate one or more AM machines 241. Process 200 includes the following manufacturing schema activity blocks: creating manufacturing definition 211, creating region based manufacturing recipe 214, and slice build plan validation/simulation 217. These processes may be executed by a graphical processing unit (GPU) or a separate processing unit. The manufacturing schema is processed by blocks 211, 214, 217 in such a way that the one or more AM edge devices 231 are not overloaded with data during execution of the AM object build. In contrast with a conventional AM build file generation that takes build information 201 and generates an AM build file to be sliced for allowing the AM machine to process the data in slices, process 200 further refines the build file generation process for more efficient AM build execution including region-based definition of geometry lattice for variable material build (e.g., deposition) features within the 3D geometry.

Given a CAD model 203 of an object, slice generation component 212 performs a slicing algorithm which is a method of discretizing the AM model according to material build layer thickness along a slicing direction. A tangent plane parallel to a 2D plane is used to cut the 3D model, and layer contour position information of each layer is obtained. This translates a 3D build into manufacturing layer by layer in a 2D plane, simplifying the manufacturing process. For the manufacturing schema-based build program generation of process 200, various slicing algorithms are available and compatible with the process, including a slicing algorithm based on a standard template library (STL) and a direct slicing algorithm based on a CAD model. In an embodiment, the STL approach is applied wherein a series of triangular patches are used to approximate the surface contour of a CAD model 203. Slices 213 are generated by a computer-based slice generation component 212, executed in this example by a GPU, which may be located in a computing device such as a user terminal.

Alternatively, a direct slicing algorithm may be implemented which can avoid problems of data redundancy, large file sizes, and long slicing times compared to the slicing with STL files. The direct slicing algorithm is executed without the need to create intermediate faceted model files and may use different layer thicknesses to directly slice the CAD model 203. Another option for the direct slicing algorithm is based on a Standard for the Exchange of Product model data (STEP) model using a geometric intersection algorithm between the tangent plane and basic curve or surface and obtaining an intersection line of a parametric surface and tangent plane.

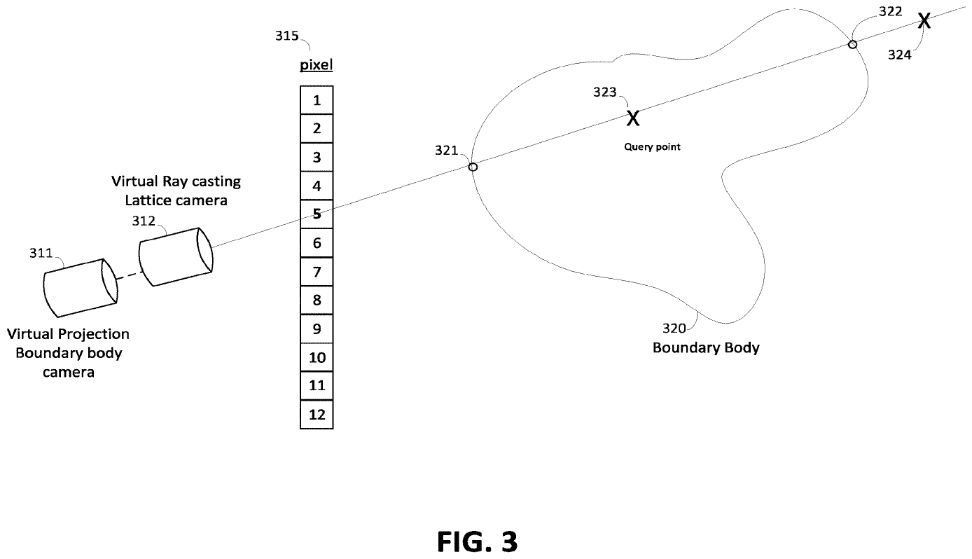

In an embodiment, a novel direct slicing approach is executed as follows. Given a CAD model 203, and a lattice definition 204 (e.g., geometry of lattice units), facets of the CAD model are loaded 222, and a lattice is created 223 using signed distance fields (SDFs) according to a ray-casting lattice representation. FIG. 3 illustrates an example of ray-casting in accordance with this embodiment. Slice generation component 212 performs the ray casting using a fragment shader, applying parallel computing over each pixel. Each pixel corresponds to a ray that shot from a virtual camera position 312 to the pixel's world coordinate 315. In this example, pixel 5 is being propagated, with boundary objects 321 and 322 detected. As the ray propagates, the SDF of the objects in the space decides the next point to query on the ray, such as query points 323, 324, which also prevents the ray from missing objects. If a query point is close enough to the objects, then it is considered that the ray hit some object at that point. The corresponding pixel color can then be calculated according to the property of the object and the illumination. Therefore, in order to obtain the whole image, the inputs of the fragment shader are always the coordinate of all pixels on the screen.

An advantage of applying the above described SDF approach is that the complexity mainly relies on the number of pixels rather than the complexity to represent the whole model with triangle meshes. Thus, large lattices can be visualized. While large lattices are unrepresentable with triangles due to memory limitations, the lattice construction performed in this method only requires local reconstruction of the SDF or implicit function around a small number of check points. Because lattices are periodical, the local SDF over a certain point is easy to find. This method is called lazy-local-reconstruction over periodical patterns and can be applied to any type of unit cell-based lattices.

At the same time, due to the nature of the fragment shader, the truncation boundary information should be available for each pixel, since the final SDF should be the lattice SDF combined with the truncating boundary's SDF. This presents two challenges: the SDF of certain shapes of the boundaries may be hard to find, and the boundaries can be as complex as the combination of hundreds of primitives. To solve this problem, a vertex shader delivers boundary information from the triangles of the boundary STL model to the related pixels. In particular, the depth buffer of the vertex shader enables processing of the boundary triangle meshes and provides points (i.e., pixels with depth) on the boundary bodies with the information of whether the far-end is inside or outside.

The fragment shader is responsible to find out the correct texture of a certain pixel from a former step, and the pixel itself comes with depth and normal to indicate the local inside/outside boundary information. With this, there are three types of input pixels for the fragment shader. First, there are pixels on the back face of the boundary body that can be seen only if no lattice stands in front of them. Second, there are pixels on the front face that are on the cross section between the boundary body and the filling lattice. From this viewpoint, the truncated lattice shares the same face with the boundary body. Third, there are pixels on the front face but not on the surface of the truncated lattice. From this viewpoint, one is able to see the lattice surface inside the boundary body or the back surface of the boundary body. The ray-casting point is farther than the front face point.

Transforming input pixels to the lattice body requires alignment of views for the virtual projection boundary body camera 311 and virtual ray casting lattice camera 312 of the fragment shader. Alignment of the virtual cameras 311, 312 enables a realization of boundary body 320 and lattice as one. Virtual cameras 311, 312 relate to geometries. The virtual projection camera 311 shows the boundary body 320 while the virtual ray casting camera 312 shows the ray casting/marching on, inside, and back face of the boundary body 320. The virtual projection camera 311 provides a trigger to the virtual ray casting lattice camera 312 to start ray marching based on the information from virtual projection camera 311 that pixel illumination is on the boundary body 320. The projection camera 311 transforms the world coordinates to screen coordinates with depth information (camera coordinate), and then passes it to the fragment shader as input. By recovering the world coordinate from the camera coordinate, the boundary information along the corresponding ray is then successfully obtained in the fragment shader. The camera may be orthogonal or a perspective camera.

With the above-describe lattice building approach, only several corresponding points are passed to each ray instead of the whole boundary body. Therefore, the algorithm can deal with more complex boundary body. Compared to prior conventional methods (e.g., truncation with primitives in fragment shaders), the algorithm can deal with any manifold boundary body that can be approximately represented by STL, such as Non-Uniform Rational B-Splines (NURBS), instead of only simple combination of primitives.

Having created the lattice SDF 223, an SDF trim operation 225 is performed to determine slice start position, slice end position and number of slices by taking a projection of the bounding box of the geometry along a specified build direction. Next, SDF Query algorithm 224 queries the SDF based on manufacturing definition 211 on each slicing plane separately to create slice 213. As an illustrative example, the lattice material in a slice 102 is shown as a white region in FIG. 1B, and regions of empty space are shown as a black region, generated by a graphics pipeline.

Ray casting algorithm 226 generates visualization 215 on a user interface to enable monitoring stages of the direct slicing. In conjunction with defect monitoring 234, the visualization 215 provides traceability backwards from manufacturing to design. In case of failure or out of spec builds in a currently monitored layer, adjustments can be made to the process, including AM machine commands for slice build 233 for the next layer, manufacturing definition 211 (for future builds), or all the way back to the design. Such backwards traceability has been missing in conventional design to manufacturing pipeline for AM.

In an embodiment, the manufacturing definition is created 211 by merging build information 201 and a manufacturing schema 202. The build information 201 is user provided inputs including specific requirements of regions within the object, which type of slicing algorithm is to be applied, and how the object is to be oriented. This manufacturing schema 202 includes information related to design specification parameters and AM machine specific details (e.g., laser power, speed of material build or deposits, material fusion), which are to be used by the specific AM machine(s) 341 regarding how to partition the geometry into sets of build information. The manufacturing specifications can be programmatically linked with local normal, contour thickness, surface finish, etc. Any changes in the geometry, design or manufacturing specification triggers an update of the affected slices or local regions in each slice, leading to modifications in the manufacturing recipe and build plan (hatch patterns, laser power, speed, etc.). The manufacturing definition 211 aids in generating the SDF query 224 on the SDF design for slicing.

In an embodiment, a region based recipe is created 214 based on the manufacturing definition 211, which can be used to create build plans on the fly for each layer and specific regions within each layer. Each slice 213 is annotated with the region based recipe 214 to create annotated slices 216. Region-based identifiers can be configured during the SDF query 224. The recipe 214 contains information regarding the type of hatch patterns and build parameters for the specified region. The annotated slices 216 can be compacted (e.g., a file size compression for faster transmission) and are individually exported to the edge device(s) 231 with the manufacturing recipe or can be sent to the slice build simulation and/or validation algorithm 217. Simulation of the slice build is performed to validate the manufacturing program.

Annotated slices 216 are received by edge device(s) 231 for processing 232 to create region-based hatching and to process parameter specifications to execute the slice build 233 as a layer build. An edge-based processor receives the region definition and manufacturing recipe and converts the information to a build file with tool path and process parameters for producing the part. The regions are derived from function aspect of the design and manufacturing optimization. The final build file is then sent from the edge device 231 to the AM machine 241 to execute the layer build. On-line sensors (e.g., camera) positioned at the one or more AM Machines 241 are implemented to monitor for defects 234 in real time as each layer is applied. For example, in a build by material deposition, an under-deposition or an over-deposition can be detected and reported as defect data to be utilized to improve the region-based manufacturing recipe generation 214 for a next slice or region. This can be further extended to improve the manufacturing recipe 211 for a current object build or subsequent object build. These adjustments are an effective error mitigation measure.

In an embodiment, the manufacturing schema of process 200 is an extensible XML based schema. It includes various identifiers for SDF designs, trimming bodies, regions, manufacturing definition and recipe that has AM build qualifiers among other information. Different extensions of the schema can be defined for different types of AM processes (e.g., binder jetting, material jetting, powder bed fusion, material extrusion, vat photopolymerization, sheet lamination, directed energy deposition) to include process specific information in the recipe. The schema relies on complimentary queries that need to be written in GLSL programming language. These queries identify the slices, slice regions and aid in creating the manufacturing recipe for a build plan. Any changes in design translates to related regions and build plan via queries. Any changes in the build plan connects to the design via region-based queries.

Advantages of the manufacturing schema based process 200 include reduction of data needed to communicate to AM machine(s) 241. The information gets compartmentalized but is still connected to the design and build plan. Any changes in the design gets propagated to the build plan or vice-versa. The amount of intermediate activity, conversion and data transfer from multiple software and hardware components is reduced. The following aspects provide these advantages: the manufacturing schema connecting designs with a manufacturing recipe, an on-demand query base generation of slices and regions with a manufacturing recipe from designs, and a delegation of toolpath creation and specification of process parameters via the recipe to an edge device for the AM machine.

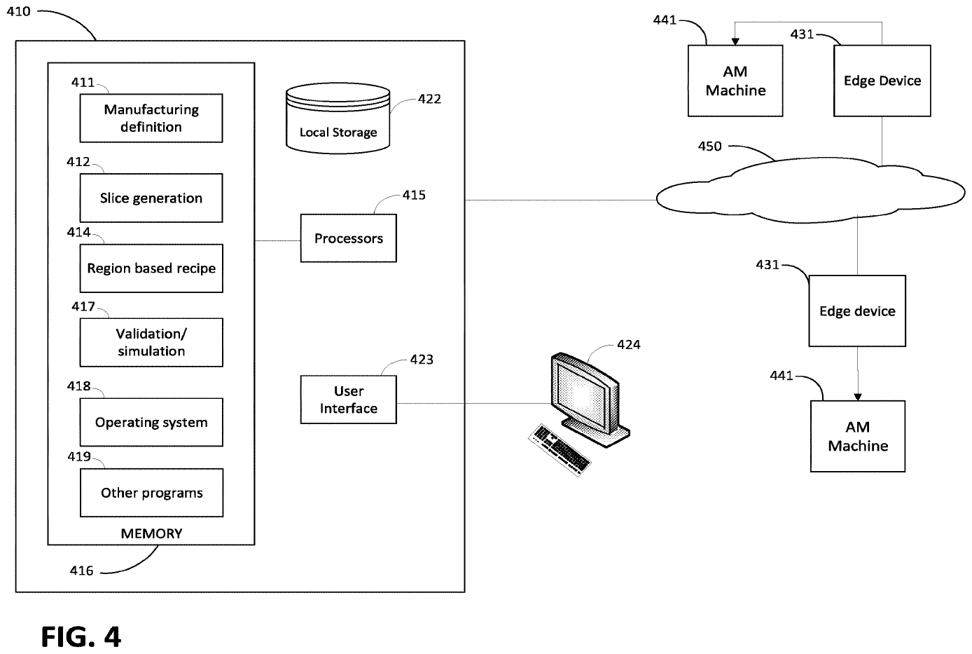

FIG. 4 shows an example of a computing environment in which embodiments of the present disclosure may operate. Computer system 410 may be embodied, for example and without limitation, as a computing device for processing manufacturing schema and AM build files for edge computing devices. As shown in FIG. 4, computing device 410 is communicatively linked to edge devices 431 which control AM machines 441.

Processors 415 may include one or more GPUs and one or more central processing units (CPUs). System memory 416 stores information and instructions to be executed by processors 415 and may be used for storing temporary variables or other intermediate information during the execution of instructions by processors 415. System memory 416 may contain data and/or program modules that are immediately accessible to and/or presently being operated on by the processors 415, such as manufacturing definition module 411, slice generation module 412, region based recipe module 414 and validation/simulation module 417, operating system 418, and other program modules 419. For this example, manufacturing definition module 411, slice generation module 412, region based recipe module 414 and validation/simulation module 417 are configured to execute the functionality of the model manufacturing definition module 211, slice generation component 212, region based recipe module 214 and validation/simulation module 217, respectively, as described above with reference to FIG. 2.

Computing system 410 may also include a user interface module 423 for communicating with a graphical user interface 424 that includes a display device to display information to a computer user, one or more input devices, such as a keyboard or pointing device, for interacting with a computer user and providing information to the processors 415. The display device may provide a touch screen interface which allows input to supplement or replace the communication of direction information and command selections.

The computing system 410 may perform a portion or all of the processing steps of embodiments of the disclosure in response to the processors 415 executing one or more sequences of one or more instructions contained in a memory, such as the system memory 416. Such instructions may be read into the system memory 416 from another computer readable storage medium, such as local storage device 422, implemented as a magnetic hard disk or a removable media drive. The local storage device 422 may contain one or more datastores and data files used by embodiments of the present disclosure. Datastore contents and data files may be encrypted to improve security. The processors 415 may also be employed in a multi-processing arrangement to execute the one or more sequences of instructions contained in system memory 416. In alternative embodiments, hard-wired circuitry may be used in place of or in combination with software instructions. Thus, embodiments are not limited to any specific combination of hardware circuitry and software.

The computing system 410 may include at least one computer readable storage medium or memory, such as local storage device 422, for holding instructions programmed according to embodiments of the disclosure and for containing data structures, tables, records, or other data described herein. The term “computer readable storage medium” as used herein refers to any medium that participates in providing instructions to the processor 415 for execution. A computer readable storage medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk or removable media drive. Non-limiting examples of volatile media include dynamic memory, such as system memory 416. Non-limiting examples of transmission media include coaxial cables, copper wire, and fiber optics. Transmission media may also take the form of acoustic or light waves, such as those generated during radio wave and infrared data communications. Computer readable program instructions described herein can be downloaded to respective computing/processing devices from a computer readable storage medium or to an external computer or external storage device via a network, for example, the Internet, a local area network, a wide area network and/or a wireless network.

Network 450 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computing system 410 and other computers such as edge computing devices 431. The network 450 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 450.

The embodiments of the present disclosure may be implemented with any combination of hardware and software. In addition, the embodiments of the present disclosure may be included in an article of manufacture (e.g., one or more computer program products) having, for example, a non-transitory computer-readable storage medium. The computer readable storage medium has embodied therein, for instance, computer readable program instructions for providing and facilitating the mechanisms of the embodiments of the present disclosure. The article of manufacture can be included as part of a computer system or sold separately.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the computing device, partly on the computing device, as a stand-alone software package, partly on the computing device and partly on a remote computer or entirely on the computing device or server. In the latter scenario, the remote computer may be connected to the computing device through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The program modules, applications, computer-executable instructions, code, or the like depicted in FIG. 4 as being stored in the system memory 416 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computing system 410, and/or hosted on other computing device(s) accessible via one or more of network, may be provided to support functionality provided by the program modules, applications, or computer-executable code and/or additional or alternate functionality. Further, functionality may be modularized differently such that processing described as being supported collectively by the collection of program modules 411, 412, 414, 417 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computing system 410 may include alternate and/or additional hardware, software, or firmware components beyond those described or depicted without departing from the scope of the disclosure. More particularly, it should be appreciated that software, firmware, or hardware components depicted as forming part of the computing system 410 are merely illustrative and that some components may not be present or additional components may be provided in various embodiments. While various illustrative program modules have been depicted and described as software modules stored in system memory 416, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented system for generating an additive manufacturing (AM) build program used to build an object conforming to a manifold boundary body, the system comprising:
a processor; and
memory having modules stored thereon with instructions to be executed by the processor, the modules comprising:
a manufacturing definition module configured to merge build information and AM machine schema information for a manufacturing definition, wherein the build information includes specification of region-based build parameters and the machine schema information includes AM machine specific parameters related to material build by layers;
a slice generation module configured to perform a direct slicing algorithm of a 3D CAD model defining the geometry for the object, wherein slices of the model are defined according to layer thickness along a slicing direction; and
a region based recipe module configured to generate annotated slices, wherein each slice is annotated with information based on the manufacturing definition;
wherein the annotated slices are sent to an edge computing device controlling the AM machine to be converted to a final build file with tool path and process parameters.

2. The system of claim 1, wherein the information of the annotated slices includes hatch pattern type and build parameters for a specified region.

3. The system of claim 1, wherein the modules further comprise:
a validation/simulation module configured to simulate the slice build to validate the manufacturing program.

4. The system of claim 1, wherein the slice generation module is further configured to:
load facets of the 3D CAD model; and
create a lattice using signed distance fields (SDFs) according to a ray-casting lattice representation using a fragment shader.

5. The system of claim 4, wherein the fragment shader receives inputs pixels including:
pixels on a back face of the boundary body;
pixels on the front face of the boundary body that are on the cross section between the boundary body and the filling lattice; and
pixels on the front face but not on the surface of the truncated lattice.

6. The system of claim 4, wherein the slice generation module is further configured to:
perform an SDF trim operation to determine slice start position, slice end position and number of slices by taking a projection of the bounding box of the geometry along a specified build direction.

7. The system of claim 4, wherein the slice generation module is further configured to:
query the SDF based on the manufacturing definition on each slicing plane separately to create the slice.

8. The system of claim 1, wherein the manufacturing definition module is further configured to receive feedback from online sensors positioned at the AM machine to monitor for defects in real time as each layer is applied.

9. A computer-implemented method for generating an additive manufacturing (AM) build program used to build an object conforming to a manifold boundary body, the method comprising:
merging build information and AM machine schema information for a manufacturing definition, wherein the build information includes specification of region-based build parameters and the machine schema information includes AM machine specific parameters related to material build by layers;
performing a direct slicing algorithm of a 3D CAD model defining the geometry for the object, wherein slices of the model are defined according to layer thickness along a slicing direction;
generating annotated slices, wherein each slice is annotated with information based on the manufacturing definition; and
sending the annotated slices are sent to an edge computing device controlling the AM machine to be converted to a final build file with tool path and process parameters.

10. The method of claim 9, wherein the information of the annotated slices includes hatch pattern type and build parameters for a specified region.

11. The method of claim 9, further comprising:
simulating the slice build to validate the manufacturing program.

12. The method of claim 9, further comprising:
loading facets of the 3D CAD model; and
creating a lattice using signed distance fields (SDFs) according to a ray-casting lattice representation using a fragment shader.

13. The method of claim 12, wherein the fragment shader receives inputs pixels including:
pixels on a back face of the boundary body;
pixels on the front face of the boundary body that are on the cross section between the boundary body and the filling lattice; and
pixels on the front face but not on the surface of the truncated lattice.

14. The method of claim 12, further comprising:
performing an SDF trim operation to determine slice start position, slice end position and number of slices by taking a projection of the bounding box of the geometry along a specified build direction.

15. The method of claim 12, further comprising:
querying the SDF based on the manufacturing definition on each slicing plane separately to create the slice.
